(19) United States
(12) Patent Application Publication
(10) Pub. No.: US 2022/0207340 A1
(43) Pub. Date: Jun. 30, 2022

(54) SYNAPSE-MIMETIC DEVICE CAPABLE OF NEURAL NETWORK TRAINING

(71) Applicants: INDUSTRY-UNIVERSITY COOPERATION FOUNDATION HANYANG UNIVERSITY ERICA CAMPUS, Ansan-si, Gyeonggi-do (KR); SEOUL NATIONAL UNIVERSITY R&DB FOUNDATION, Seoul (KR)

(72) Inventors: Saeroonter OH, Ansan-si, Gyeonggi-do (KR); Sangbum KIM, Seoul (KR)

(73) Assignees: INDUSTRY-UNIVERSITY COOPERATION FOUNDATION HANYANG UNIVERSITY ERICA CAMPUS, Ansan-si, Gyeonggi-do (KR); SEOUL NATIONAL UNIVERSITY R&DB FOUNDATION, Seoul (KR)

(21) Appl. No.: 17/610,027

(22) PCT Filed: May 21, 2020
(86) PCT No.: PCT/KR2020/006613

§ 371 Date: Nov. 9, 2021

(30) Foreign Application Priority Data
May 24, 2019 (KR) 10-2019-0061270
Feb. 20, 2020 (KR) 10-2020-0021308

(51) Int. Cl. G06N 3/063

(52) U.S. Cl. CPC G06N 3/063

(57) ABSTRACT

A synapse-mimetic device includes: a capacitor; a first transistor which connects a first power supply to a first end of the capacitor in response to a first control signal; a second transistor which connects a second power supply to a second end of the capacitor in response to a second control signal; a third transistor which connects the first power supply to the second end of the capacitor in response to a third control signal; a fourth transistor which connects the second power supply to the first end of the capacitor in response to a fourth control signal; and a fifth transistor which provides, to an output line, a current determined by the voltage of the first end of the capacitor, the voltage of the input line, and the voltage of the output line.

### CROSS-REFERENCE TO PRIOR APPLICATIONS

This application is a National Stage patent Application of PCT International Patent Application No. PCT/KR2020/006613 (filed on May 21, 2020) under 35 U.S.C. § 371, which claims priority to Korean Patent Application Nos. 10-2019-0061270 (filed on May 24, 2019) and 10-2020-0021308 (filed on Feb. 20, 2020), which are all hereby incorporated by reference in their entirety.

### BACKGROUND

The present disclosure relates to a synapse-mimetic device, and more particularly, to a synapse-mimetic device capable of neural network training.

In the current von Neumann computer architecture, frequent movement of large amounts of data between a processor and a memory causes long delays and large power consumption, which leads to a limitation of chip performance. Currently, software-based deep neural network computation has used AI accelerator hardware such as high-performance CPU, GPU, and ASIC, but due to data bottlenecks, a computation speed is slowed and power consumption is very high.

A cranial nerve simulation architecture directly performs computations at a location of a memory device in which data is stored, and stores and updates connection strength (synaptic weight) between neuron devices in the memory device, resulting in better integration and energy efficiency than the existing computing architectures.

The number of devices connected to the next-generation IoT network is expected to increase significantly from 8 billion in 2017 to 70 billion in 2025, but due to the lack of deep neural network computation in mobile devices and IoT devices, they are dependent on cloud or data server computation. In the hyper-connected information and communication society, it is necessary to dramatically reduce the power consumption required for data operation and communication.

In the era of the 4th industrial revolution, which is represented by hyper-connectivity based on IoT and big data technology, a new concept computing technology that minimizes power consumption and is innovatively differentiated from existing methods is required. A cranial nerve simulation computation method, which receives a large amount of unstructured data and has high energy efficiency like the human brain, is a next-generation computing solution required for artificial intelligence, big data, sensor networks, pattern/object recognition, and the like.

Research on cranial nerve simulation computation devices so far has focused on securing symmetrical and linear conductivity increase and decrease characteristics of multiple conduction levels using a resistance change memory, a phase change memory, a ferroelectric memory, and the like. However, due to the non-ideal characteristics of the experimental memory device, the neural network implemented in hardware is far behind the recognition and classification accuracy of the software-based deep neural network. Hardware implementation using an analog memory has the advantage of high energy efficiency, but the advantage of neural network computation efficiency can be maximized when software-level training accuracy is achieved.

The non-volatile memory devices of the existing research were only suitable for inference among training to update weights of synapse devices and inference to recognize and classify images, objects, voices, and the like. This is because there are physical and technical limitations with the existing memory devices since the number of conduction levels required for efficient training is 2 (about 1000) or more, and the increase and decrease of synapse weights need to be symmetrical and linear.

In order to overcome this limitation, in the existing studies, the training was performed in software, and only the inference function was performed in hardware by moving the synapse weight value to an analog memory array.

### SUMMARY

The present disclosure provides a synapse-mimetic device capable of neural network training with a software-level on-chip learning ability and software-level accuracy by implementing symmetric and linear training characteristics without using an existing analog memory device.

In an aspect, a synapse-mimetic device includes: a capacitor; a first transistor which connects a first power supply to a first end of the capacitor in response to a first control signal; a second transistor which connects a second power supply to a second end of the capacitor in response to a second control signal; a third transistor which connects the first power supply to the second end of the capacitor in response to a third control signal; a fourth transistor which connects the second power supply to the first end of the capacitor in response to a fourth control signal; and a fifth transistor which provides, to an output line, a current determined by the voltage of the first end of the capacitor, the voltage of the input line, and the voltage of the output line.

When training the synapse-mimetic device, a potentiation operation or a depression operation may be repeatedly performed to set the voltage across the capacitor as a target voltage.

During the potentiation operation, the first control signal may be activated, and the second control signal may be periodically activated.

During the potentiation operation, the first control signal and the second control signal may be activated for a first time among a predetermined unit time.

The voltage of the first control signal may be higher than that of the second control signal.

During the depression operation, the third control signal may be activated, and the fourth control signal may be periodically activated.

During the depression operation, the third control signal and the fourth control signal may be activated for a second time among a predetermined unit time.

When reading the synapse-mimetic device, the second control signal may be activated.

When reading the synapse-mimetic device, the third control signal may be activated.

The first transistor, the second transistor, the third transistor, and the fourth transistor may be an amorphous InGaZnO field effect transistor (FET), a polycrystalline InGaZnO FET, a single crystalline InGaZnO FET, or a C-axis grown crystal InGaZnO (C-axis aligned InGaZnO) FET.

The first transistor, the second transistor, the third transistor, and the fourth transistor may be metal oxide transistors including at least one of In, Ga, Zn, Sn, Al, Hf, Zr, Si, and O.

A synapse-mimetic device according to an embodiment of the present disclosure can implement symmetric and linear training characteristics, enabling hardware-based neural network training that can reduce energy consumption and required time for training while having software-level accuracy.

In addition, a synapse-mimetic device according to an embodiment of the present disclosure is made of an oxide semiconductor that makes it easy to perform a three-dimensional integration process through low-temperature deposition, so it can be manufactured as a three-dimensional integrated synapse cell to reduce a cell circuit area.

### BRIEF DESCRIPTION OF THE DRAWINGS

In order to more fully understand the drawings recited in the detailed description of the present disclosure, a detailed description of each drawing is provided.

FIG. 1 is a conceptual diagram of a cranial nerve simulation computation system according to an embodiment of the present disclosure.

FIG. 2 is a circuit diagram of a synapse-mimetic device illustrated in FIG. 1.

FIG. 3 is a diagram illustrating a first embodiment of a waveform diagram of control signals supplied to the synapse-mimetic device illustrated in FIG. 2 during a potentiation operation.

FIG. 4 is a diagram illustrating a second embodiment of a waveform diagram of control signals supplied to the synapse-mimetic device illustrated in FIG. 2 during the potentiation operation.

FIG. 5 is a diagram illustrating a first embodiment of a waveform diagram of control signals supplied to the synapse-mimetic device illustrated in FIG. 2 during a depression operation.

FIG. 6 is a diagram illustrating a second embodiment of a waveform diagram of control signals supplied to the synapse-mimetic device illustrated in FIG. 2 during the depression operation.

FIG. 7 illustrates a first embodiment of a waveform diagram of control signals supplied to the synapse-mimetic device illustrated in FIG. 2 during a read operation.

FIG. 8 is a diagram illustrating a second embodiment of a waveform diagram of control signals supplied to the synapse-mimetic device illustrated in FIG. 2 during the read operation.

FIG. 9 is a graph showing a change in a voltage Vc across a capacitor illustrated in FIG. 2 during the potentiation operation and the depression operation.

FIG. 10 is a graph showing a change Iinf of an output current illustrated in FIG. 2 during the potentiation operation and the depression operation.

### DETAILED DESCRIPTION

Specific structural or functional descriptions disclosed in the present specification will be provided only in order to describe exemplary embodiments of the present disclosure. Therefore, exemplary embodiments of the present disclosure may be implemented in various forms, and the present disclosure is not to be interpreted as being limited to exemplary embodiments described in the present specification.

Since exemplary embodiments of the present disclosure may be variously modified and may have several forms, they will be shown in the accompanying drawings and be described in detail in the present specification. However, it is to be understood that exemplary embodiments of the present disclosure are not limited to specific forms, but include all modifications, equivalents, and substitutions included in the spirit and the scope of the present disclosure.

Terms such as ‘first’, ‘second’, or the like, may be used to describe various components, but these components are not to be construed as being limited to these terms. The terms are used only to distinguish one component from another component. For example, the ‘first’ component may be named the ‘second’ component and the ‘second’ component may also be similarly named the ‘first’ component, without departing from the scope of the present disclosure.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element interposed therebetween. In addition, other expressions describing a relationship between components, that is, “between”, “directly between”, “neighboring to”, “directly neighboring to” and the like, should be similarly interpreted.

Terms used in the present specification are used only in order to describe specific embodiments rather than limiting the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless defined otherwise, all the terms used in the present specification, including technical and scientific terms, have the same meanings as meanings that are generally understood by those skilled in the art to which the present disclosure pertains. Terms generally used and defined in a dictionary are to be interpreted as the same meanings with meanings within the context of the related art, and are not to be interpreted as ideal or excessively formal meanings unless clearly indicated in the present specification.

Hereinafter, exemplary embodiments of the present disclosure will be described in detail with reference to the accompanying drawings.

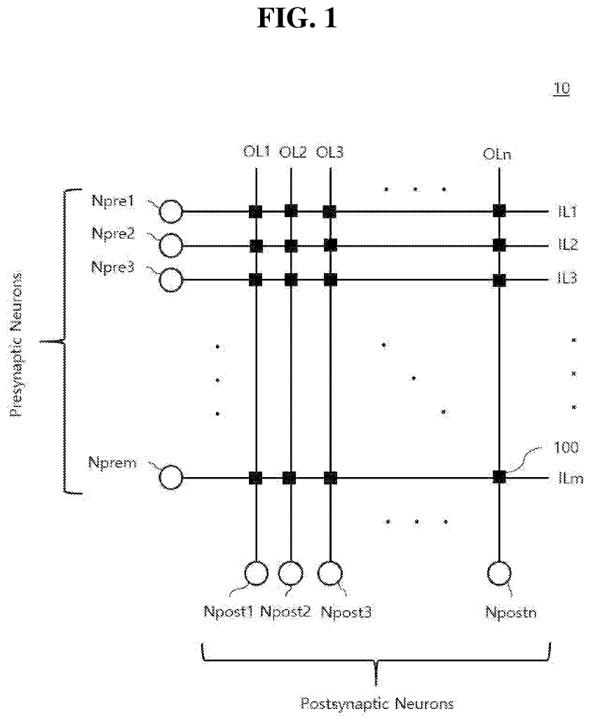

FIG. 1 illustrates a conceptual diagram of a cranial nerve simulation computation system according to an embodiment of the present disclosure.

FIG. 1 is a configuration diagram of neurons and synapses required for cranial nerve simulation computation, and in presynaptic neurons, input data (voltage) is sent to a synapse cell array in the form of a crossbar, and in postsynaptic neurons, a current value (I=GV, G stores a conductivity value of each synapse in the form of an array) from the synapse cell array is read. For the update method of the conductivity value of each synapse, the update value can be determined by forward propagation/back propagation according to the neural network computation method, or a spike-timing dependent plasticity learning rule may be used locally.

Referring to FIG. 1, the cranial nerve simulation computation system 10 includes presynaptic neurons Nprel to Nprem, postsynaptic neurons Npostl to Npostn, and a plurality of synapse-mimetic devices 100.

In FIG. 1, for convenience, lines connected to the presynaptic neurons Nprel to Nprem are expressed as input lines IL1 to ILm, and lines connected to the postsynaptic neurons Npostl to Npostn are expressed as output lines OL1 to OLn, which is only to separately describe the lines connected to the presynaptic neurons Nprel to Nprem and the lines connected to the postsynaptic neurons Npostl to Npostn.

For example, during a forward propagation operation in which input values are transmitted from the presynaptic neurons Nprel to Nprem to the postsynaptic neurons Npostl to Npostn through the synapse-mimetic devices 100, input lines IL1 to ILm may act as input lines and output lines OL1 to OLn may act as output lines.

On the other hand, during a backward propagation operation in which input values are transmitted from the postsynaptic neurons Npostl to Npostn to the presynaptic neurons Nprel to Nprem through the synapse-mimetic devices 100, the input lines IL1 to ILm may act as the output lines and the output lines OL1 to OLn may act as the input lines.

Hereinafter, the concept of the present disclosure will be described assuming the forward propagation operation unless otherwise specified, but the concept of the present disclosure is not limited thereto.

The synapse-mimetic device 100 is provided between any one of the presynaptic neurons Nprel to Nprem and any one of the post-synaptic neurons Npostl to Npostn.

Although omitted in FIG. 1, the synapse-mimetic device 100 receives control signals from an external circuit (peripheral circuit, not illustrated).

The external circuit (not illustrated) updates a weight of the synapse-mimetic device 100 by repeatedly outputting the control signals to the synapse-mimetic device 100 during training. In other words, the external circuit (not illustrated) may potentiate or depress the synapse-mimetic device 100 by outputting the control signals having a predetermined waveform to the synapse-mimetic device 100.

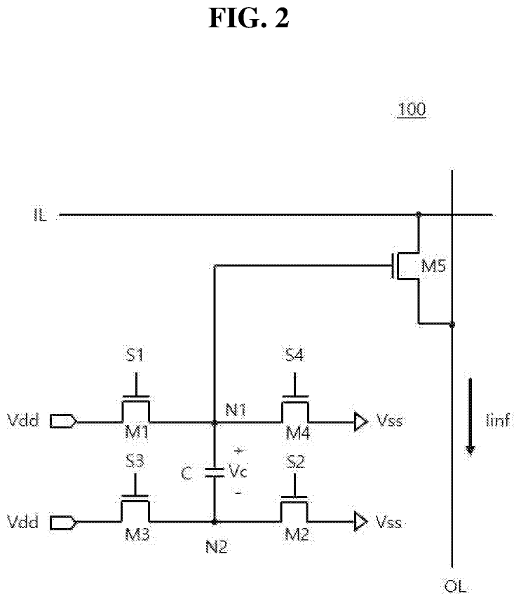

When training the cranial nerve simulation computation system 10, the external circuit (not illustrated) sets a voltage Vc across the capacitor (FIG. 2C) included in the synapse-mimetic device 100 as a target voltage. In this case, the potentiation operation or depression operation is repeatedly performed the number of times corresponding to a difference between the charged voltage and the target voltage.

FIG. 2 is a circuit diagram of the synapse-mimetic device illustrated in FIG. 1.

Referring to FIG. 2, the synapse-mimetic device 100 includes a capacitor C and a plurality of transistors M1 to M5.

The capacitor C is connected between a first node N1 and a second node N2.

A first transistor M1 is connected between a first power supply Vdd and a first node N1, and is switched in response to a first control signal S1.

A second transistor M2 is connected between a second power supply Vss and a second node N2, and is switched in response to a second control signal S2.

A third transistor M3 is connected between the first power supply Vdd and a second node N2, and is switched in response to a third control signal S3.

A fourth transistor M4 is connected between a second power supply Vss and the first node N1, and is switched in response to a fourth control signal S4.

After the training for the synapse-mimetic device 100 is finished, only when the weights set in the synapse-mimetic device 100 needs to be maintained, inference according to the learning results is possible. Since the weight is stored as the voltage Vc across the capacitor C, it is preferable that the first to fourth transistors M1 to M4 have a low off-current, that is, a low leakage current in an off state.

For example, the first to fourth transistors M1 to M4 may be implemented as an amorphous InGaZnO FET, a polycrystalline InGaZnO FET, or a monocrystalline InGaZnO FET, or may be implemented as a metal oxide transistor including at least one of In, Ga, Zn, Sn, Al, Hf, Zr, Si, and O.

In particular, the C-axis growth crystal InGaZnO FET has been reported to have an off-current of about 10⁻²⁴ [A/μm]. This is because leakage current components due to the multi-carrier accumulation mode operation device of the metal oxide transistor, a high band gap, a high sub-gap state near a valence band, and a high hole effective mass are completely blocked.

The fifth transistor M5 supplies a current Iinf determined by the voltage of the first node N1, the voltage of the input line IL and the voltage of the output line OL to the output line OL.

During the backward propagation operation, the fifth transistor M5 supplies the current Iinf determined by the voltage of the first node N1, the voltage of the input line IL and the voltage of the output line OL to the input line IL.

A first terminal of the fifth transistor M5 is connected to the input line IL to which any one of the presynaptic neurons Nprel to Nprem is connected. A second terminal of the fifth transistor M5 is connected to the output line OL to which any one of the post-synaptic neurons Npostl to Npostn is connected. A gate terminal of the fifth transistor M5 is connected to the first node N1.

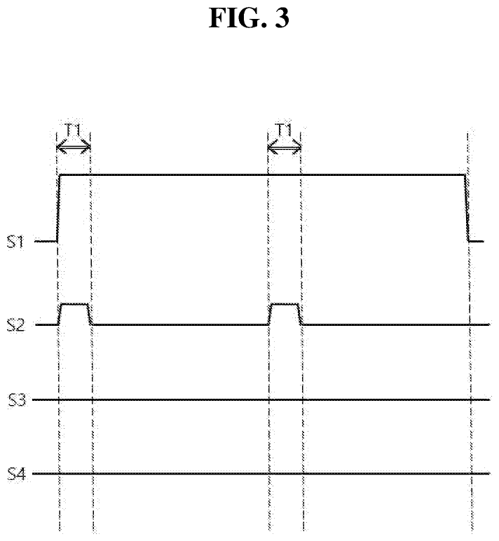

FIG. 3 is a diagram illustrating a first embodiment of a waveform diagram of control signals supplied to the synapse-mimetic device illustrated in FIG. 2 during a potentiation operation.

Referring to FIG. 3, an external circuit (not illustrated) repeatedly performs the potentiation operation the determined number of times to increase the weight of the synapse-mimetic device 100 during the training.

The external circuit (not illustrated) may continuously activate the first control signal S1 and periodically activate the second control signal S2 for a first time T1 when performing the potentiation operation.

In this case, the external circuit (not illustrated) may activate the first control signal S1, having a predetermined time margin before activating the second control signal S2.

The first transistor M1 and the second transistor M2 are turned on for the first time T1 when the first control signal S1 and the second control signal S2 are simultaneously activated. Accordingly, the voltage Vc across the capacitor C is stepped-up for the first time T1.

The voltage of the first control signal S1 may be set to be higher than that of the second control signal S2.

For example, the voltage of the second control signal S2 may be set to be higher than or equal to a threshold voltage of the second transistor M2 so that the second transistor M2 may operate in a saturation region, and the voltage of the first control signal S1 may be set to be much higher than the threshold voltage of the first transistor M1, that is, higher than the voltage of the second control signal S2 so that a source terminal and a drain terminal of the first transistor M1 may be connected without a voltage loss.

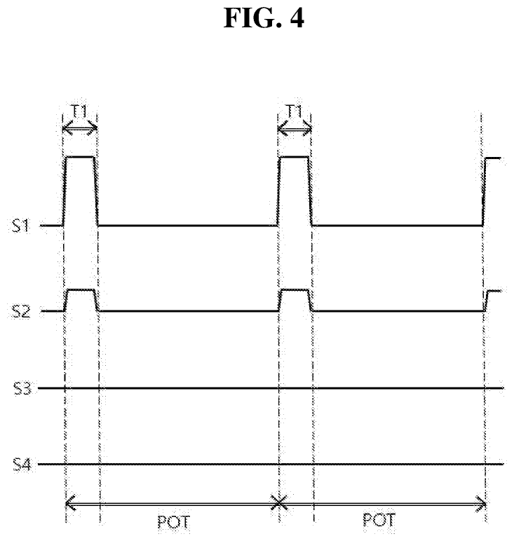

FIG. 4 is a diagram illustrating a second embodiment of a waveform diagram of control signals supplied to the synapse-mimetic device illustrated in FIG. 2 during the potentiation operation.

Referring to FIG. 4, the external circuit (not illustrated) repeatedly performs the potentiation operation the determined number of times to increase the weight of the synapse-mimetic device 100 during the training.

The external circuit (not illustrated) activates the first control signal S1 and the second control signal S2 for the first time T1 among a unit time POT when performing the potentiation operation.

In this case, the external circuit (not illustrated) may activate the first control signal S1, having a predetermined time margin before activating the second control signal S2.

The first transistor M1 and the second transistor M2 are turned on for the first time T1 when the first control signal S1 and the second control signal S2 are activated. Accordingly, the voltage Vc across the capacitor C is stepped-up for the first time T1.

The voltage of the first control signal S1 may be set higher than that of the second control signal S2.

For example, the voltage of the second control signal S2 may be set to be higher than or equal to a threshold voltage of the second transistor M2 so that the second transistor M2 may operate in a saturation region, and the voltage of the first control signal S1 may be set to be much higher than the threshold voltage of the first transistor M1, that is, higher than the voltage of the second control signal so that a source terminal and a drain terminal of the first transistor M1 may be connected without a voltage loss.

The first time T1 may be set to be constant so that the step-up amount of the voltage Vc is constant for one unit time POT.

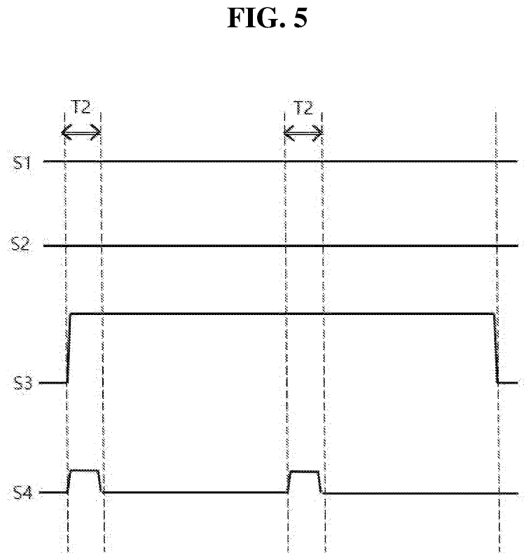

FIG. 5 is a diagram illustrating a first embodiment of a waveform diagram of control signals supplied to the synapse-mimetic device illustrated in FIG. 2 during a depression operation.

Referring to FIG. 5, the external circuit (not illustrated) repeatedly performs the depression operation the determined number of times to decrease the weight of the synapse-mimetic device 100 during the training.

The external circuit (not illustrated) may continuously activate the third control signal S3 and periodically activate the fourth control signal S4 for a first time T1 when performing the depression operation.

In this case, the external circuit (not illustrated) may activate the third control signal S3, having a predetermined time margin before activating the fourth control signal S4.

The third transistor M3 and the fourth transistor M4 are turned on for the first time T2 when the first control signal S1 and the second control signal S2 are simultaneously activated. Accordingly, the voltage Vc across the capacitor C is stepped-down for the second time T2.

The voltage of the third control signal S3 may be set to be higher than that of the fourth control signal S4.

For example, the voltage of the fourth control signal S4 may be set to be higher than or equal to a threshold voltage of the fourth transistor M4 so that the fourth transistor M4 may operate in a saturation region, and the voltage of the third control signal S3 may be set to be much higher than the threshold voltage of the third transistor M3, that is, higher than the voltage of the second control signal S4 so that a source terminal and a drain terminal of the third transistor M3 may be connected without a voltage loss.

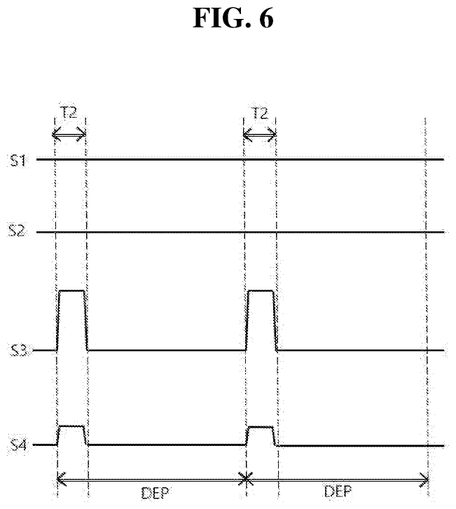

FIG. 6 is a diagram illustrating a second embodiment of a waveform diagram of control signals supplied to the synapse-mimetic device illustrated in FIG. 2 during the depression operation.

Referring to FIG. 6, the external circuit (not illustrated) repeatedly performs the depression operation the determined number of times to decrease the weight of the synapse-mimetic device 100 during the training.

The external circuit (not illustrated) activates the third control signal S3 and the fourth control signal S4 for the second time T2 among a unit time DEP when performing the depression operation.

In this case, the external circuit (not illustrated) may activate the fourth control signal S4, having a predetermined time margin before activating the third control signal S3.

The third transistor M3 and the fourth transistor M4 are turned on for the second time T2 when the third control signal S3 and the fourth control signal S4 are activated. Accordingly, the voltage Vc across the capacitor C is stepped-down for the second time T2.

The voltage of the third control signal S3 may be set to be higher than that of the fourth control signal S4.

For example, the voltage of the fourth control signal S4 may be set to be higher than or equal to a threshold voltage of the fourth transistor M4 so that the fourth transistor M4 may operate in a saturation region, and the voltage of the third control signal S3 may be set to be much higher than the threshold voltage of the third transistor M3, that is, higher than the voltage of the second control signal S4 so that a source terminal and a drain terminal of the third transistor M3 may be connected without a voltage loss.

The second time T2 may be set to be constant so that the step-down amount of the voltage Vc is constant for one unit time DEP.

According to an embodiment, the length of the first time T1 and the length of the second time T2 may be set so that the unit step-up amount during the potentiation operation and the unit step-down amount during the depression operation are the same.

According to an embodiment, the length of the unit time POT in the potentiation operation and the length of the unit time DEP in the depression operation may be set to be the same.

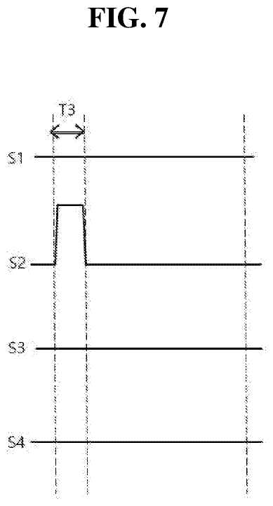

FIG. 7 illustrates a first embodiment of a waveform diagram of control signals supplied to the synapse-mimetic device illustrated in FIG. 2 during a read operation.

Referring to FIG. 7, the external circuit (not illustrated) activates the second control signal S2 for a third time T3 to read the synapse-mimetic device 100.

When the second control signal S2 is activated, the current Iinf determined by the voltage of the first node N1, the voltage of the input line IL, and the voltage of the output line OL is supplied to the output line OL.

When the second control signal S2 is activated, the voltage of the first node N1 corresponds to the voltage Vc across the capacitor C.

Since the magnitude of the current Iinf is controlled by the voltage Vc across the capacitor C, the voltage Vc across the capacitor C may serve as the weight of the synapse-mimetic device 100.

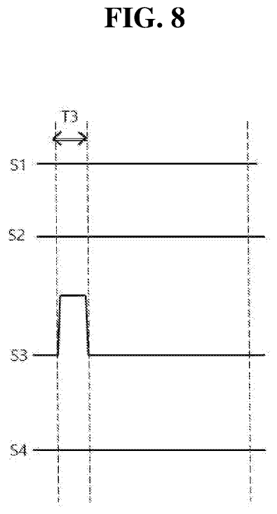

FIG. 8 is a diagram illustrating a second embodiment of a waveform diagram of control signals supplied to the synapse-mimetic device illustrated in FIG. 2 during the read operation.

Referring to FIG. 8, the external circuit (not illustrated) activates the third control signal S3 for the third time T3 to read the synapse-mimetic device 100.

When the third control signal S3 is activated, the current Iinf corresponding to the voltage difference between the voltage of the input line IL and the first node N1 is supplied to the output line OL.

When the third control signal S3 is activated, the voltage of the first node N1 corresponds to the sum of the first power supply Vdd and the voltage Vc across the capacitor C.

Since the magnitude of the current Iinf is controlled by the sum of the first power supply Vdd and the voltage Vc across the capacitor C, the voltage Vc across the capacitor C may serve as the weight of the synapse-mimetic device 100.

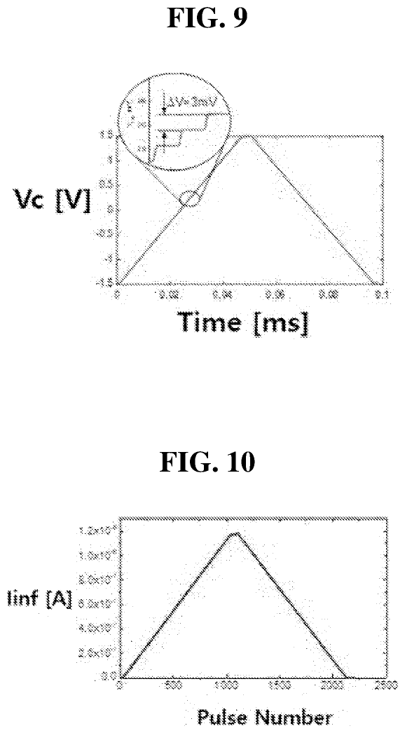

FIG. 9 is a graph showing the change in the voltage Vc across the capacitor illustrated in FIG. 2 during the potentiation operation and the depression operation, and FIG. 10 is a graph showing the change Iinf in the output current illustrated in FIG. 2 during the potentiation operation and the depression operation.

FIG. 9 illustrates a result of simulating the change in the Vc across the capacitor C included in the synapse-mimetic device 100 when performing about 1,000 potentiation operations for about 0.05 ms for the synapse-mimetic device 100 and then performing about 1,000 depression operations for about 0.05 ms.

As illustrated in FIG. 9, the voltage Vc across the capacitor was stepped-up by 3 mV during the unit potentiation operation. Although not illustrated in detail in FIG. 9, the voltage Vc across the capacitor was stepped-down by 3 mV during the unit depression operation.

FIG. 10 illustrates a result of simulating the change in the current linf output from the synapse-mimetic device 100 through the output line OL when performing about 1,000 potentiation operations for about 0.05 ms for the synapse-mimetic device 100 and then performing about 1,000 depression operations for about 0.05 ms.

As illustrated in FIGS. 9 and 10, for the synapse-mimetic device 100 according to the embodiment of the present disclosure, the weight linearly changes during the potentiation operation or the depression operation, and the amount of voltage/current change in the unit potentiation operation and the amount of voltage/current in the unit depression operation are the same, and thus, symmetrical.

The synapse-mimetic device according to the embodiment of the present disclosure can implement symmetric and linear training characteristics, enabling hardware-based neural network training that can reduce energy consumption and required time for training while having software-level accuracy.

In addition, the synapse-mimetic device according to the embodiment of the present disclosure is made of an oxide semiconductor that is easy to perform a three-dimensional integration process through low-temperature deposition, so it can be manufactured as a three-dimensional integrated synapse cell to reduce a cell circuit area.

Although the present disclosure has been described with reference to exemplary embodiments shown in the accompanying drawings, they are only examples. It will be understood by those skilled in the art that various modifications and equivalent other exemplary embodiments are possible from the present disclosure. Accordingly, an actual technical protection scope of the present disclosure is to be defined by the following claims.

1. A synapse-mimetic device comprising:
a capacitor;
a first transistor which connects a first power supply to a first end of the capacitor in response to a first control signal;
a second transistor which connects a second power supply to a second end of the capacitor in response to a second control signal;
a third transistor which connects the first power supply to the second end of the capacitor in response to a third control signal;
a fourth transistor which connects the second power supply to the first end of the capacitor in response to a fourth control signal; and
a fifth transistor which provides, to an output line, a current determined by the voltage of the first end of the capacitor, the voltage of the input line, and the voltage of the output line.

2. The synapse-mimetic device of claim 1, wherein when training the synapse-mimetic device, a potentiation operation or a depression operation is repeatedly performed to set the voltage across the capacitor as a target voltage.

3. The synapse-mimetic device of claim 2, wherein during the potentiation operation,
the first control signal is activated, and
the second control signal is periodically activated.

4. The synapse-mimetic device of claim 2, wherein during the potentiation operation, the first control signal and the second control signal are activated for a first time among a predetermined unit time.

5. The synapse-mimetic device of claim 3, wherein the voltage of the first control signal is higher than that of the second control signal.

6. The synapse-mimetic device of claim 2, wherein during the depression operation,
the third control signal is activated, and
the fourth control signal is periodically activated.

7. The synapse-mimetic device of claim 2, wherein during the depression operation,
the third control signal and the fourth control signal are activated for a second time among a predetermined unit time.

8. The synapse-mimetic device of claim 2, wherein when reading the synapse-mimetic device, the second control signal is activated.

9. The synapse-mimetic device of claim 2, wherein when reading the synapse-mimetic device, the third control signal is activated.

10. The synapse-mimetic device of claim 1, wherein the first transistor, the second transistor, the third transistor, and the fourth transistor are an amorphous InGaZnO field effect transistor (FET), a polycrystalline InGaZnO FET, a single crystalline InGaZnO FET, or a C-axis grown crystal InGaZnO (C-axis aligned).

11. The synapse-mimetic device of claim 1, wherein the first transistor, the second transistor, the third transistor, and the fourth transistor are metal oxide transistors including at least one of In, Ga, Zn, Sn, Al, Hf, Zr, Si, and O.

12. A synapse-mimetic device comprising:
a capacitor;
a potentiation transistor including first and second transistors and configured to couple one of terminals of the capacitor to a first power supply and the other of the terminals of the capacitor to a second power supply during a potentiation operation to gradually increase a charge of the capacitor; and
a depression transistor including third and fourth transistors and configured to couple the other of terminals of the capacitor to a third power supply and the one of the terminals of the capacitor to a fourth power supply during a depression operation to gradually decrease a charge of the capacitor.

13. A synapse-mimetic device comprising:
a capacitor;
first and second learning transistors M1 and M4 being coupled to a first node N1 of the capacitor; and
third and fourth learning transistors M2 and M3 being coupled to a second node N2 of the capacitor,
wherein a voltage is applied to the second transistor M2 or a third transistor M3 during a read operation.
